(19) United States
(12) Patent Application Publication
(10) Pub. No.: US 2018/0350337 A1
(43) Pub. Date: Dec. 6, 2018

(54) ELECTRONIC MUSICAL INSTRUMENT WITH SEPARATE PITCH AND ARTICULATION CONTROL

(71) Applicant: Eric Netherland, San Diego, CA (US)

(72) Inventor: Eric Netherland, San Diego, CA (US)

(21) Appl. No.: 15/876,093

(22) Filed: Jan. 19, 2018

Related U.S. Application Data
(60) Provisional application No. 62/448,124, filed on Jan. 19, 2017.

(51) Int. Cl. G10H 1/00; G10H 1/18; G10H 1/46; G10H 1/44; G10H 5/00

(52) U.S. Cl. CPC G10H 1/0066; G10H 1/183; G10H 1/46; G10H 2220/241; G10H 5/002; G10H 2220/096; G10H 1/44

(57) ABSTRACT

In one embodiment, an electronic musical instrument (EMI) (or “electronic multi-instrument) is described that separates pitch choice from percussive sound control (“articulation”). A pitch sensor interface (by which notes are selected) may comprise a software-programmed touchscreen interface (that can be modeled on existing musical instruments or entirely new) configured to allow pitch choice, while sound control may be made on a separate articulation control sensor (by which notes are triggered and modified), such as an illustrative double-sided touch pad, that senses one or more of a velocity, pressure, movement, and location of a user's contact. The design facilitates a portable, ergonomic, and intuitive way to express music via standard digital protocols (e.g., MIDI) through a physical interface that encourages fluid, non-static, personally distinguishable musical expression. Notably, the instrument may illustratively be a controller that requires a compatible synthesizer sound source (e.g., on-board or separate).

### RELATED APPLICATION

This application claims priority to U.S. Provisional Application No. 62/448,124 filed Jan. 19, 2017, entitled “ELECTRONIC MUSICAL INSTRUMENT WITH SEPARATE PITCH AND ARTICULATION CONTROL,” by Eric Netherland, the contents of which are hereby incorporated by reference.

### TECHNICAL FIELD

The present disclosure relates generally to electronic musical instruments, and, more particularly, to an electronic musical instrument with separated pitch and articulation control.

### BACKGROUND

Existing electronic musical instruments (EMIs) tend to be modeled on a well-known, traditional acoustic instrument, such as the piano, guitar, or saxophone. Electronic disc-jockeys (DJs) are also limited to the form factors of laptops, switchboards, electronic turntables, etc.

Moreover, existing keyboard or percussion EMIs also combine pitch selection and sound triggering (articulation) within the same hand placement. For example, an electronic keyboard has a series of keys, where depressing a first key produces a first sound (first pitch), depressing a second key produces a second and different sound (second pitch), and so on. This makes bends or modulations (changing the pitch of a sound) awkward and unnatural and limits rhythmic control.

Additionally, existing guitar EMIs separate pitch from rhythm control, but fixed fret buttons do not allow bending pitch in a natural way. Also, existing wind and percussion EMIs lack the flexibility to play in any other way.

Still further, conventional touchscreen EMIs, such as simple piano keys projected on a tablet screen, provide no sense of touch, no velocity, and no volume control. That is, such instruments do not determine how hard a key was hit, so there is no control over how soft or loud a sound is to be played.

### SUMMARY

According to one or more embodiments herein, an electronic musical instrument (EMI) (or “electronic multi-instrument”) is described that separates pitch choice from percussive sound control (“articulation”). A pitch sensor interface (by which notes are selected) may comprise a software-programmed touchscreen interface (that can be io modeled on existing musical instruments or entirely new) configured to allow pitch choice, while sound control may be made on a separate articulation control sensor (by which notes are triggered and modified), such as an illustrative double-sided touch pad, that senses one or more of a velocity, pressure, movement, and location of a user's contact. The design facilitates a portable, ergonomic, and intuitive way to express music is via standard digital protocols (e.g., MIDI) through a physical interface that encourages fluid, non-static, personally distinguishable musical expression. Notably, the instrument may illustratively be a controller that requires a compatible synthesizer sound source (e.g., on-board or separate).

This separation of pitch from articulation/percussion solves several problems faced by existing electronic musical instruments providing greater detail for expression of each note, improved rhythmic feel, natural pitch movement, and more precise velocity control.

Notably, this summary is meant to be illustrative of certain example aspects and embodiments of the detailed description below, and is not meant to be limiting to the scope of the present invention herein.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example procedure for an electronic musical instrument with separate pitch and articulation control according to various embodiments and aspects herein;

FIG. 2 example another procedure for an electronic musical instrument with separate pitch and articulation control according to various embodiments and aspects io herein;

FIG. 3 illustrates an example block diagram and communication arrangement for an electronic musical instrument with separate pitch and articulation control according to various embodiments and aspects herein;

FIG. 4 illustrates an example of an XY (or XYZ) touch pad for use with separate is pitch and articulation control according to various embodiments and aspects herein;

FIG. 5 illustrates an example of a dual-sided articulation sensor component for use with an electronic musical instrument with separate pitch and articulation control according to various embodiments and aspects herein;

FIGS. 6A-6G illustrate an example of a particular arrangement of an electronic musical instrument with separate pitch and articulation control according to one illustrative embodiment herein;

FIG. 7 illustrates an example of a dual-sided peripheral control device;

FIGS. 8-9 illustrate block diagrams of parallel and serial communications for peripheral control devices; and

FIGS. 10-12 illustrate further example embodiments and configurations of peripheral control devices.

### DESCRIPTION OF EXAMPLE EMBODIMENTS

Electronic musical instruments (EMIs), such as Musical Instrument Digital Interface (MIDI) controller instruments and synthesizers, have many capabilities. However, the controller mechanisms, although numerous, are disjointed and difficult to manage. For example, sliders, wheels, foot controllers, and so on are conventional features used for enhanced electronic control, which may be located at random places on an instrument. Furthermore, certain instruments may not have such features at all, and some musicians might desire such features or even greater control. For example, some electronic keyboards have a built-in pitch-bender lever or wheel, where played notes may io be bent in pitch (e.g., ½ tone up and/or down). However, not all electronic keyboards have such functionality, and those that do have pitch-benders are limited to merely bending pitch.

The novel EMI described herein, on the other hand, solves these problems by offering a single ergonomic multi-sided articulation surface that provides a way to fluidly is and intuitively manipulate performance parameters and rhythm. This surface integrates with any pitch selection component to allow seamless transitions between staccato/legato articulations, timbre, amplitude, and pitch-bend. The techniques described below also allow for the use of a touchscreen interface that does not support force, so that natural velocity can be easily added to this interface.

As described below, the system need not directly emulate any particular instrument, yet any musician regardless of background can adapt to play (e.g., being a guitar, keyboard, wind instrument, percussion instrument, and so on, or even another non-standard interface).

According to one or more embodiments described herein, the illustrative EMI allows for various interfaces to be displayed and/or used for pitch selection. Rhythmic playing is enhanced by addition of a separate tactile input controller to trigger selected notes and to modulate tone. In particular, as described in greater detail below, a combination of input methods, such as combining a touchscreen with a touchpad, creates a unique combination of input methods allowing for flexible playing styles, more precise rhythmic control, and more fluid/natural way to control complex performance parameters.

Specifically, according to a first aspect of the present disclosure described in greater detail below, an adaptable touchscreen configuration may provide a graphic user interface that can be programmed via software into a unique note configuration or modeled on an existing acoustic instrument (e.g., keyboard, strings, valves, percussion, etc.). It can also dynamically adapt to left or right-handed playing, varied hand sizes, and other user requirements. According to a second aspect of the present disclosure described in greater detail below, the separation of note selection and note trigger solves two io problems in touchscreen-based instruments: velocity and latency. That is, touchscreens do not easily detect strike velocity, and as such the volume of a note is no different between a softly struck note and a firmly struck note. Also, regarding latency, touchscreen scan rates are generally too low to pick up very fast pitch changes. Moving the note trigger to a separate articulation (or percussion) pad, which detects velocity with is no limitation on scan rate, solves both problems.

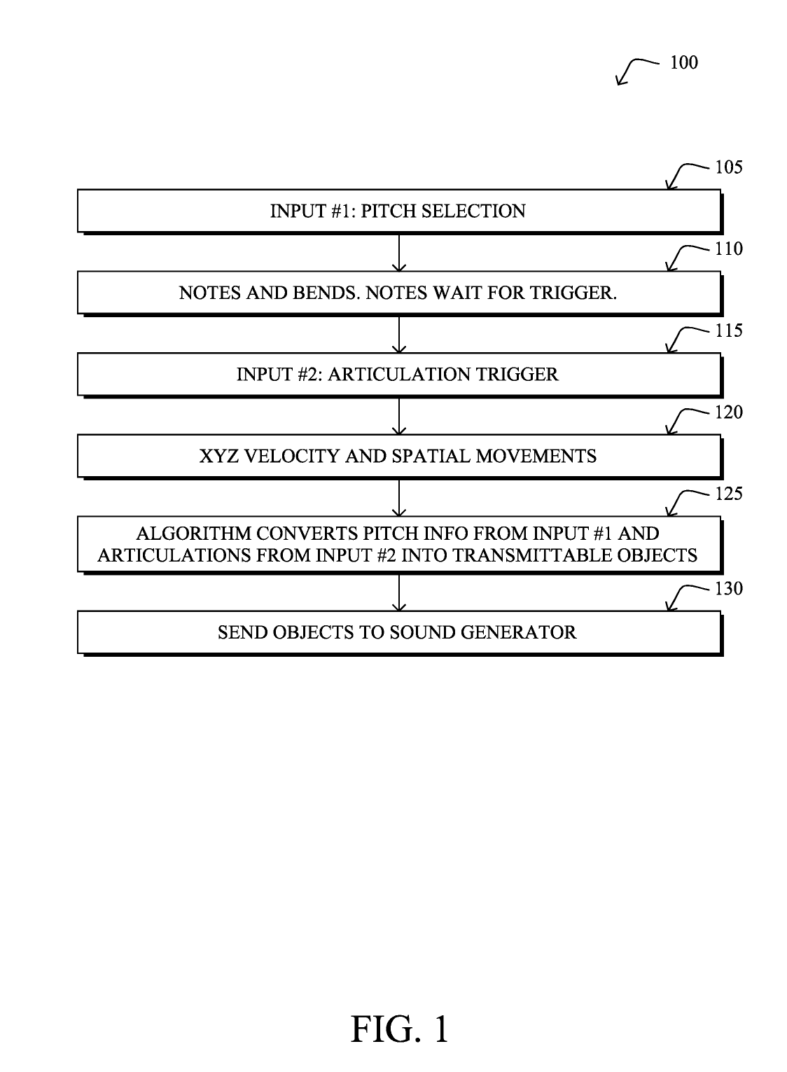

FIG. 1 illustrates an example simplified procedure for use by control software to implement one or more aspects of the techniques herein, which are described in greater detail below. For instance, in the procedure 100 of FIG. 1, pitch selection is the first input (step 105), where the control software stores notes and bends (step 110), and awaits a trigger from the articulation sensor (step 115). Once a second input from the articulation trigger occurs (step 115), then based on sensed velocity and spatial movements (e.g., XYZ control) (step 120), the control software algorithm combines the pitch information from the pitch sensor with the articulations from the articulation sensor into transmittable objects (step 125), and sends corresponding objects to a sound generator (step 130).

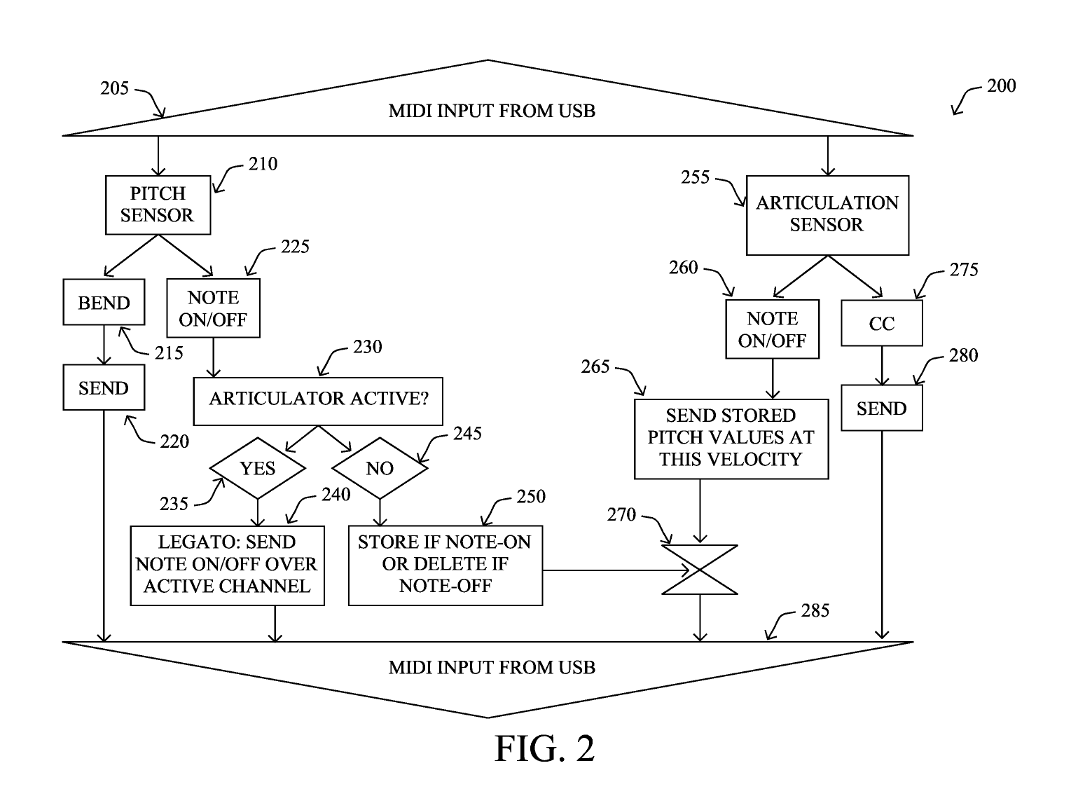

FIG. 2, on the other hand, illustrates a more detailed example of the above procedure for combining the inputs from the pitch sensor and articulation sensor. Specifically, in one embodiment, an example procedure 200 may take input from a musical communication medium (step 205), such as MIDI input from a USB line. A pitch sensor input may be received (step 210), and can determined to indicate a pitch bend (step 215) which can be sent (step 220) to the output (step 285), such as a MIDI output to a USB line. The pitch sensor received (in step 210) may also indicate a note “on/off” signal (step 225), at which time the process determines whether the articulator is also active (step 230). If active (step 235), then for legato, the process sends the note on/off signal over the active channel (step 240) to the output (step 285). On the other hand, if the articulator is not active (step 245), then the process stores the note if a note-on signal or deletes it if a note-off signal (step 250). The stored note is used (i.e., sent to the output) based on the articulation sensor (step 270). In particular, from the input signaling (step 205), the articulation sensor may also be sensed (step 255), which can io indicate a note on/off signal as well (step 260), which may result in sending stored pitch values (from step 250) at a detected velocity (step 265) to the output. Alternatively, the articulation sensor (step 255) may also produce a control change (CC) signal (step 275), which can be sent (step 280) to the output, accordingly. Those skilled in the art will appreciate that the procedure 200 illustrated in FIG. 2 is merely one example implementation, and is not meant to limit the scope of the embodiments herein.

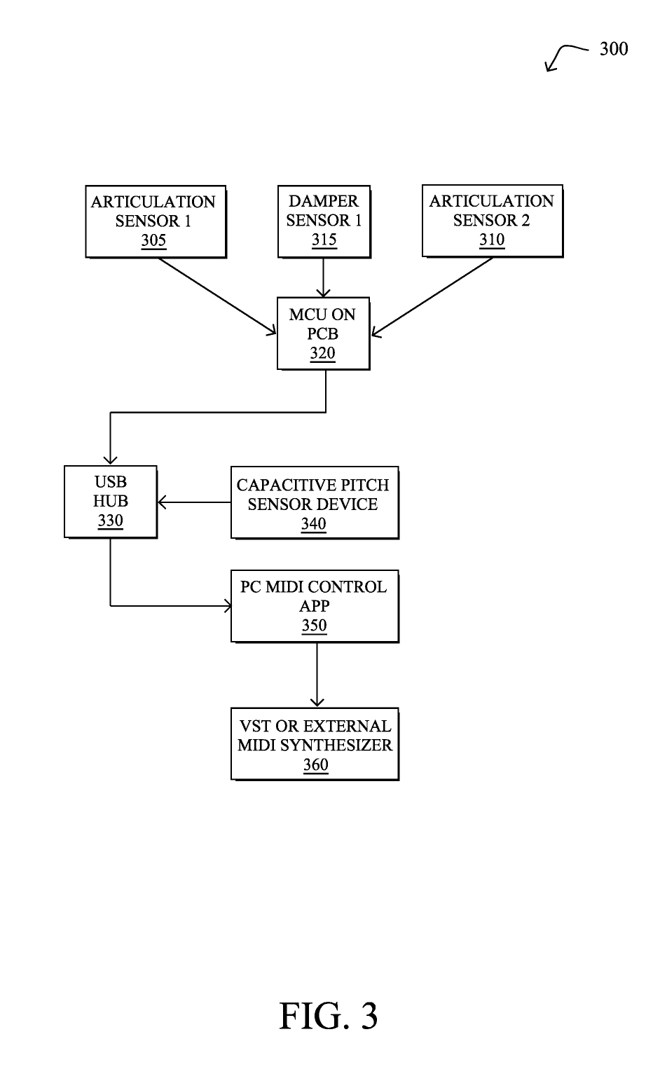

Furthermore, for general reference during the description below, FIG. 3 illustrates an example block diagram of an illustrative EMI configuration 300, where dual articulation sensors 305 and 310, as well as a damper sensor 315 (each as described below) may be connected (e.g., via a “Mackie Control” or “MCU” on a printed circuit board (PCB) 320) to a USB hub 330, as well as the pitch sensor device 340 (e.g., capacitive or otherwise, as described herein). The USB hub may then connect the signal to a MIDI control application 350, which then processes the signal(s) for output to virtual studio technology (VST) or an external MIDI synthesizer 360.

According to the techniques herein, a primary component of the embodiments herein is pitch control for the EMI. As such, various types of pitch detection sensors (PS) may be used. For instance, a pitch detection (or control) sensor may be configured as either a hardware sensor array (e.g., physical piano keys or other buttons with sensor pickup technology) or a software-defined touch-sensitive display (e.g., a displayed image of piano keys on a touchscreen, such as a midi keyboard). Singular and/or plural note selection is supported, and in the illustrative (and preferred) embodiment herein, selected notes need not (and preferably do not) trigger until the articulation sensor (e.g., pad/exciter) portion is “struck”.

According to an illustrative embodiment, the pitch sensor may be configured as an open touchscreen interface that can be programmed via software into a unique configuration or modeled on an existing acoustic instrument (keyboard, strings, valves, percussion, etc.), as a user's choice. Touching the visible graphics (that is, selecting one or more independent notes, chords, sounds, etc.) will select the musical notes, and sliding between notes may allow for corresponding pitch changes. Pitch selection can be polyphonic or monophonic. Once the note is selected, sliding movements will create io pitch bends or vibrato, based on lengths and directions determined by the software. This leads to flexible and intuitive pitch control similar to an acoustic instrument but only limited by the software and the client synthesizer.

Said differently, pitch selection may be illustratively embodied as a touchscreen capable of detecting X axis and Y axis position and movements , and that is capable of is translating X/Y positions to musical notes (e.g., MIDI notes, such as fretted or keyboard quantized) and pitch-bend (high-resolution) data. The touchscreen may be a variable design (e.g., touchscreen with display capabilities), or may be fixed (e.g., touchpad with printed graphics). Also, in one embodiment, the actual pitch selection sensor component may be fixed to the EMI, or may be removable and/or interchangeable (e.g., different locations of a pitch selection component from the articulation component described below, or else for interchanging between different (static) pitch selection configurations, such as switching from a piano keyboard to a guitar fretboard).

(Note that as described below, pitch selection may be capable seamless detection of pitch in between notes, i.e., independent note pitch-bend (e.g., multidimensional polyphonic expression, “MPE”). The pitch sensor herein, therefore, solves the issue of pitch-bend not being per note via the MIDI spec, as described below.)

Another primary component of the embodiments herein is articulation control (rhythm, percussion, etc.) for the EMI. An articulation/excitation sensor (AS) assembly is illustratively a multi-faceted ergonomic touch-sensitive sensor array for enhanced musical expression. In one preferred embodiment, a double-sided touch pad may be struck by a human hand and it (e.g., in conjunction with sensor-reading software) may measure the velocity, pressure, location, and movement of the hand strike. The touch pad provides tactile feedback and can be struck in many ways and in multiple areas, such as, for example, simple tapping or pressing, strumming up and down like a guitar, drummed like a tabla, or by sliding back and forth like a violin. The X/Y spatial location of the strike can determine tone, crossfade between different sounds, etc., depending upon implementation. Strikes on each side of a double-sided pad could be set to arpeggiate for an up/down strum-like effect. The range of effects is only limited by software and the client synthesizer.

In more general detail, an example touchpad may be a force-sensing resistor (or force-sensitive resistor) (FSR) pad, which illustratively comprises FSR 4-wire sensors for XYZ sensing, preferably with enough space and resolution for ease of sliding hand movement to facilitate natural musical articulations, such as, among others, timbre, harmonics, envelope, bowing, sustain, staccato, pizzicato, etc. Though a simple is embodiment merely requires a touch “on/off” sensing ability, and even more sophistication with a force-sensing ability (i.e., velocity or “how hard” a user strikes the pad), the illustratively preferred XYZ sensor indicates response from three dimensions: X-axis, Y-axis, and Z-axis (force/velocity). That is, the main surfaces of an illustrative touchpad use 3D plane resistive touch sensor technology for X, Y, and Z axis position response.

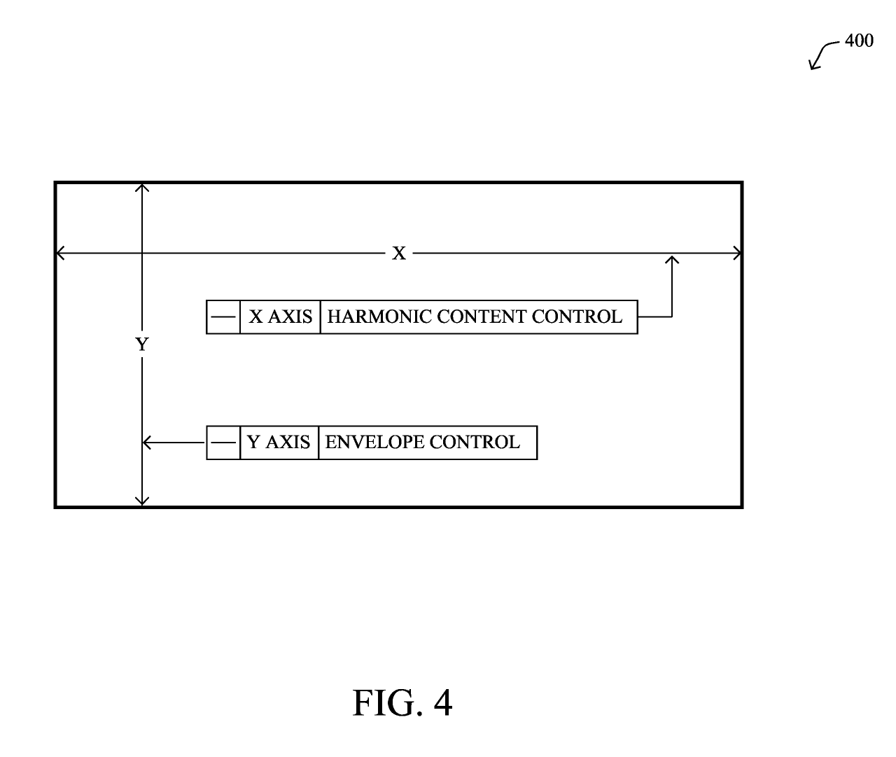

Illustratively, and with reference to diagram 400 of FIG. 4, the X/Y axes may translate to certain controller data. For instance, in one embodiment, such data may comprise a MIDI continuous controller data output, such as where the X dimension corresponds to harmonic content (e.g., timbre), while the Y dimension corresponds to envelope. Alternatively, the X and Y axes may be transposed, or used for other controls, which may be configured by the associated synthesizer or software system. The Z axis (in/out of the diagram 400) may illustratively translate to velocity or volume data (e.g., MIDI controls). In one embodiment, the initial strike for velocity may be followed by amplitude data control from pressure, that is, additional Z pressure when already depressed may correlate to further velocity or “aftertouch”.

In one embodiment, the XYZ FSR sensor design and firmware may be capable of low-latency, e.g., <1 ms, velocity detection. In another embodiment, the XYZ sensor outputs data using the universal serial bus (USB) communication protocol.

In general, on the articulation control, pad strikes determine, for one or more notes, the velocity/amplitude/transient. Subsequent note movement while the pad is active may result in (no transient) Legato articulation. Subsequent pad strikes may then result in re-triggering of the selected note transient. In certain embodiments, the location of the strike on a pad may result in various timbre and/or envelope modifications of the sound. Furthermore, velocity is determined by force and velocity of striking the pad. io Subsequent force after the strike may control Legato amplitude, unless using a velocity capable keyboard for pitch selection. In that case Legato velocity may be determined by the MIDI keyboard input.

The use of an articulation sensor thus solves the issue that touchscreens generally do not provide force sensitivity to allow for velocity information, as well as the issue that is pitch-bend/modulation wheels are awkward to use simultaneously. Moreover, the use of an articulation sensor in this manner also expands continuous controller (CC) expression and versatility, as may be appreciated by those skilled in the art (e.g., as defined by the MIDI standards).

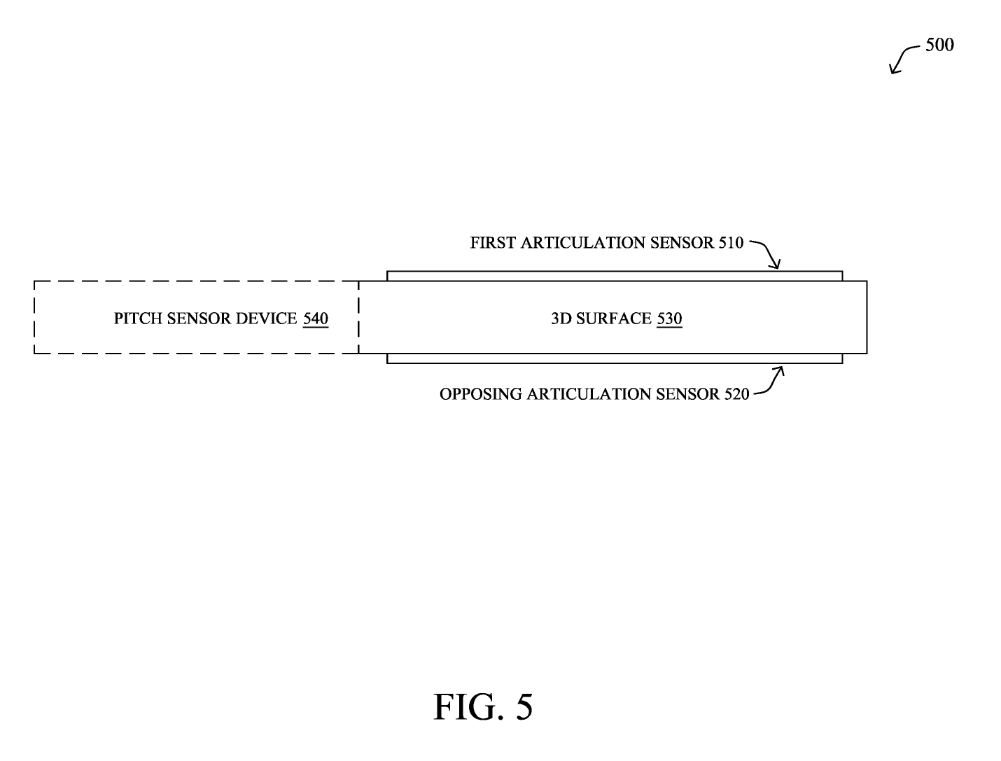

Multi-faceted ergonomic touch sensitive articulation sensors, such as a dual-sided articulation sensor configuration 500 shown in FIG. 5, allows for intuitive musical articulation. In particular, when the articulation sensor consists of two XYZ FSR sensors 510 and 520 (and optionally one position potentiometer ribbon dampening sensor, described below) mounted on a three-dimensional object/surface 530 (e.g., a rectangular cuboid surface), a user's hand may contact both sides in an alternating (e.g., bouncing or strumming) or simultaneous manner (e.g., squeezing or holding). The surfaces may be designed to be comfortable for a human hand to strike and to slide to indicate musical articulations from two sides. Illustratively, XYZ sensors may be positioned orthogonally (90-degrees) or opposing (180-degrees), or any other suitable angle, in order to facilitate rapid, repeating, rhythmic hand strikes that trigger MIDI note on/note off. The articulation sensor arranged as a an opposing pair in this manner allows keyboard (or other instruments/pitch sensor devices 540) to easily play rapid fire chords or notes, based on the bi-directional rhythm triggering/“strumming” with velocity controlled note delay.

Said differently, each FSR pad may be located on opposite sides of a hand-sized parallelepiped (or rectangular cuboid) facilitating rapid percussive strikes and sliding movements over the X/Y axis. The Z axis can also be accessed following a strike by applying pressure. The axis movements may send data in a mirror configuration to facilitate natural up and down strikes of a hand (e.g., sliding the hand in the same direction). That is, the two XYZ sensors may be (though need not be) identical in size io and shape, and mirror axis movements such that natural movements from both sides intuitively result in the same expressions. This also facilitates left or right hand play and a variety of play variations. In one embodiment, however, as an alternative to synchronized articulation pads, each pad may offer individual input and control, for more advanced control and instrument play.

According to one or more embodiments herein, the EMI may be preferably configured to combine the pitch selection control and the articulation/excitation control. For instance, in one embodiment, one hand of a user/player may select pitch on the touchscreen (pitch sensor), while the other hand triggers the sound by striking the touch pad (articulation sensor). The harder (more velocity) the articulation sensor is struck, the louder the notes selected by the pitch sensor may be played. The longer the articulation is held down, the longer the notes selected by the pitcher sensor may be played. Similarly, as described above, sliding the user's fingers along the touchscreen (e.g., in the X and or Y axis direction) allows for various control and/or expression (e.g., sliding to pitch-bend, circling to create natural vibrato, or “fretless” slide effect, and so on). This separation of control provides greater detail and flexibility for a wider range of musical expressions (which is particularly good for percussive playing styles, but can be played in a variety of ways depending on implementation).

Note that striking the touch pad without selecting a pitch may be configured trigger a non-pitched percussive sound for rhythmic effect. That is, without any selected pitch, tapping the articulation sensor may produce a muted sound, such as muted/dampened strings, hitting the body of an acoustic guitar, or other percussive sounds or noises as dictated by the associated control software. Note that selecting notes on the pitch sensor without striking the articulation sensor may generally be mute (i.e., no sound), or else alternatively, if so configured, may play as legacy mode e.g., “tapping”.

In one embodiment, touching and holding an articulation sensor (or both articulation sensors simultaneously) may enable other play modes, such as legacy mode to allow piano-like playback from the pitch sensor, i.e., standard single hand keyboard play with note-on triggering control transferred back to the pitch selection component. In this mode, X/Y movement on the articulation sensor and its corresponding functionality io may remain active. Moreover, additional Z-axis pressure/force (e.g., “squeezing” the pad) may control volume/velocity, though in alternative configurations in this mode, other axis movement (e.g., X-axis) may be used to control volume/velocity. This is particularly useful if the pitch selection device is a capacitive touchscreen that does not support force detection. Further, other arrangements may be made, such as holding down is a first articulation sensor to allow piano play by the pitch sensor, and pressing on a second articulation sensor for features such as sustain.

According to one or more embodiments herein, a damper sensor may be used to facilitate quick, intuitive dampening of ringing notes during play. For instance, the EMI may comprise one or two damper sensor(s), e.g., ribbon soft-pot voltage detection sensors, which may be positioned in proximity to the XYZ sensor or between dual XYZ sensors (e.g., orthogonally to the other sensors). Illustratively, a damper sensor only requires on/off functionality, e.g., to send MIDI CC 64 data. Notably, this damper sensor (e.g., 315 above) may be generally an additional sensor, and may be used for any suitably configured control, such as to mute, sustain, damper, etc., as well as any other control program change (e.g., tone changes, program changes, instrument changes, etc., such as cycling through various configurations/programs, accordingly).

As mentioned above, control software according to the techniques herein may comprise a computer-based application (e.g., desktop, laptop, tablet, smartphone, etc.) that supports input from the EMI and peripheral control device (e.g., USB) and EMI input/output (I/O) generally (e.g., MIDI). The communication between the EMI, peripheral control device, and the control software may illustratively be USB direct, though other embodiments that utilize one or more of wireless, MIDI, Ethernet, and so on. Note that in one embodiment, the control software may be integrated into the EMI hardware for a more self-contained implementation, or else in another embodiment may be contained remotely (e.g., through a wired or wireless connection, or even over an Internet connection) on a standard operating system (OS) such as MICROSOFT WINDOWS, APPLE MACOSX or IOS, or ANDROID operating systems.

As also mentioned above, the pitch sensor may be capable of high scan rates for low latency detection, as well as the articulation sensor, and the control sensor is thus correspondingly configured to correlate the differentiated sensor input and translate the input from both sensors into a digital musical standard for output, e.g., MIDI. For example, the control software may correlate and store the pitch sensor information, and then may trigger the pitch data at rhythmic moments, velocity, and durations as dictated by strikes to the articulation sensor(s).

The control software may also be configured to manage the configuration of the EMI, such as the mode and configuration of the pitch sensor, as well as to select from various presets to manage user configurations and synthesizers. Other controls, such as managing channel and pitch-bend data via MPE standards, or else further capability of managing MIDI input parsing and output MIDI commands. Further, the control software may be capable of creating and storing user presets to manage setups, configurations, ranges, CC data mapping, and so on.

Note that because of the unique configuration of the separated pitch sensor and articulation sensor(s), various musical features are made available by the embodiments herein. For instance, polyphonic pitch-bend (Multidimensional Polyphonic Expression or “MPE”) with re-triggering support during bend, and polyphonic pitch-bend (MPE) with full legato support, i.e., mono synth style envelope response with chords (e.g., a super lap steel guitar style play). (Polyphonic legato is similar to a guitar's “hammer on” technique.) Note that the MPE allows for pitch-per-note control, i.e., independent control of each note, and not simply all selected notes moving in the same direction (e.g., ½ tone up/down), but however so configured and/or controlled (e.g., some notes up, some down). (At the same time, of course, simultaneous pitch-bend, XYZ articulation, and rhythm triggering, are configurable and controllable in any suitable manner as well.) Various abilities to slide between notes are available in different configurations, e.g., sliding along a cello between strings, a keyboard shifting from triad to 6/9 chord, etc. Further, subtle randomness of XY locations of note triggers can create a less static, unique-to-player sound. Additional articulation and pitch capabilities are thus offered than conventional MIDI controllers.

The physical layout of the EMI described herein may vary based on user design, preference, and style. Having a virtual interface provides the advantages of any interface io for any type player, and allows adjustable interface for different styles, hand sizes, etc. In addition, a virtual interface provides something unique for the audience to see while performing. The display on a touchscreen, or any physically changeable pitch sensor modules, may consist of any of a keyboard, strings, valves, percussion, DJ controller boards, or other custom/alternative designs. In one embodiment, touchscreen technology is that actually changes shape (e.g., “bubble-up” technology) may be used to add a tactile feel (e.g., key or valve locations) for user sensation. There could even be a non-musician mode for singer self-accompaniment without knowledge of any traditional instruments.

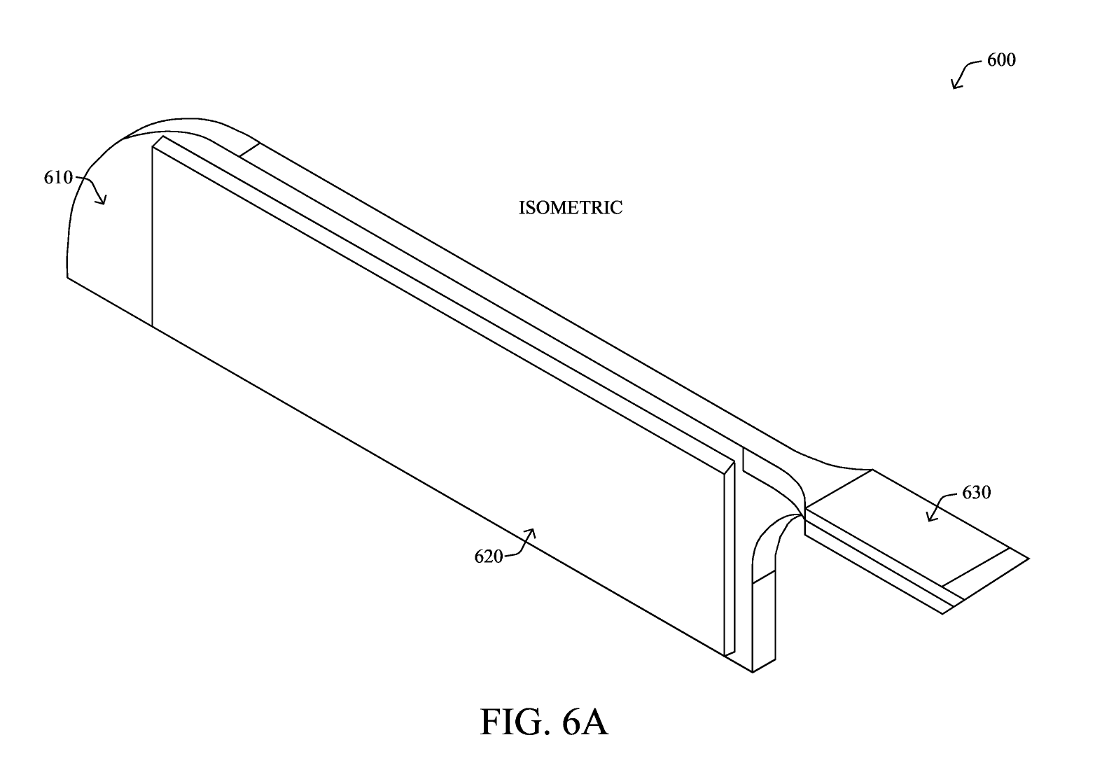

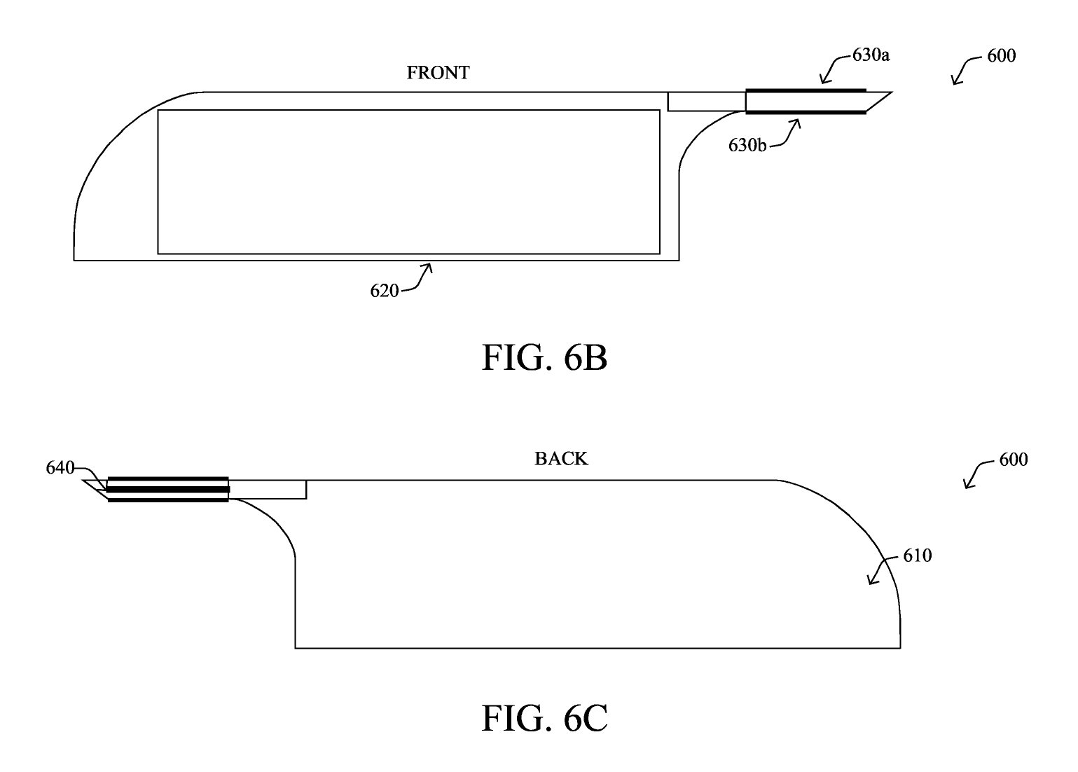

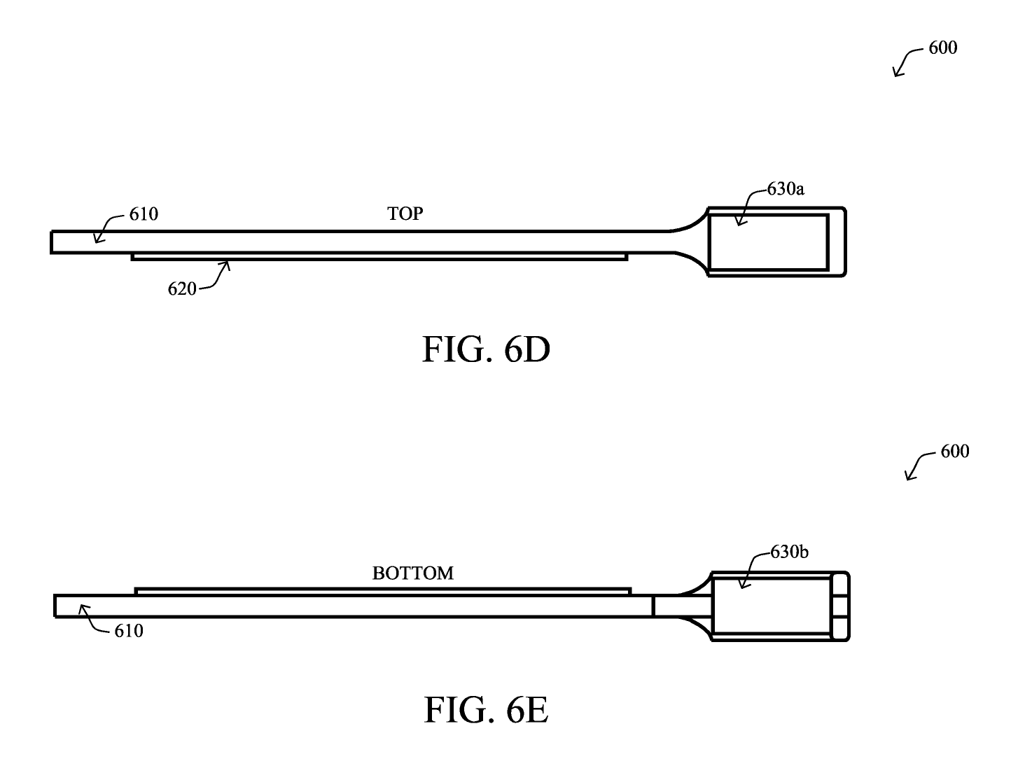

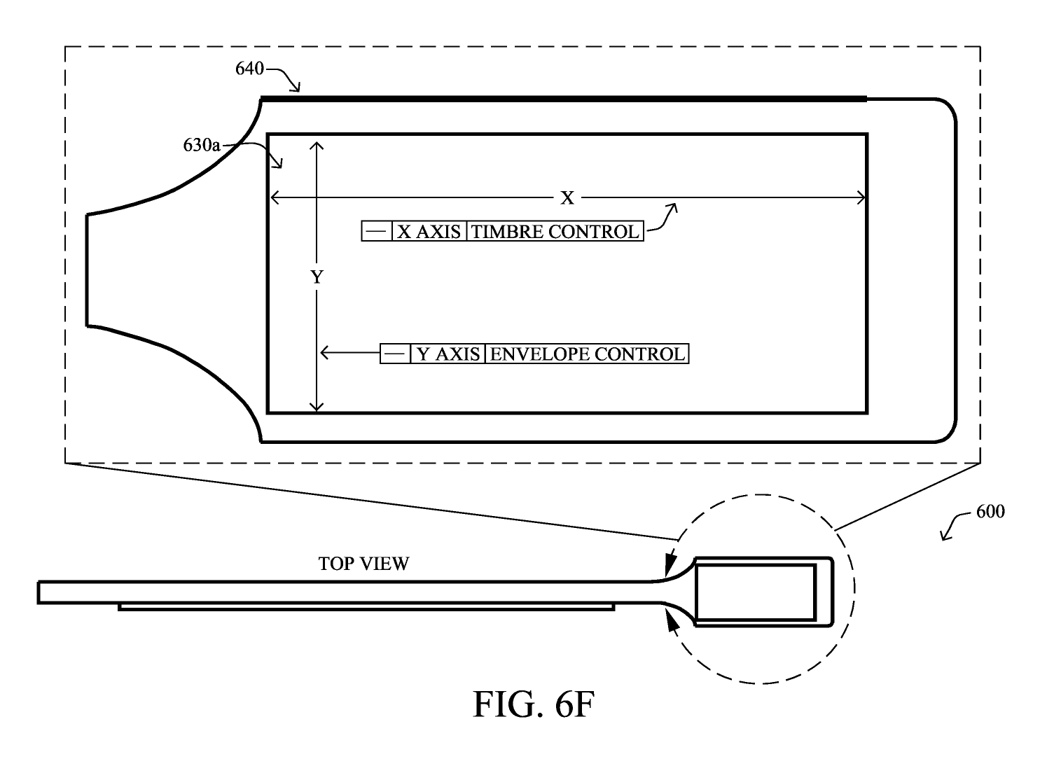

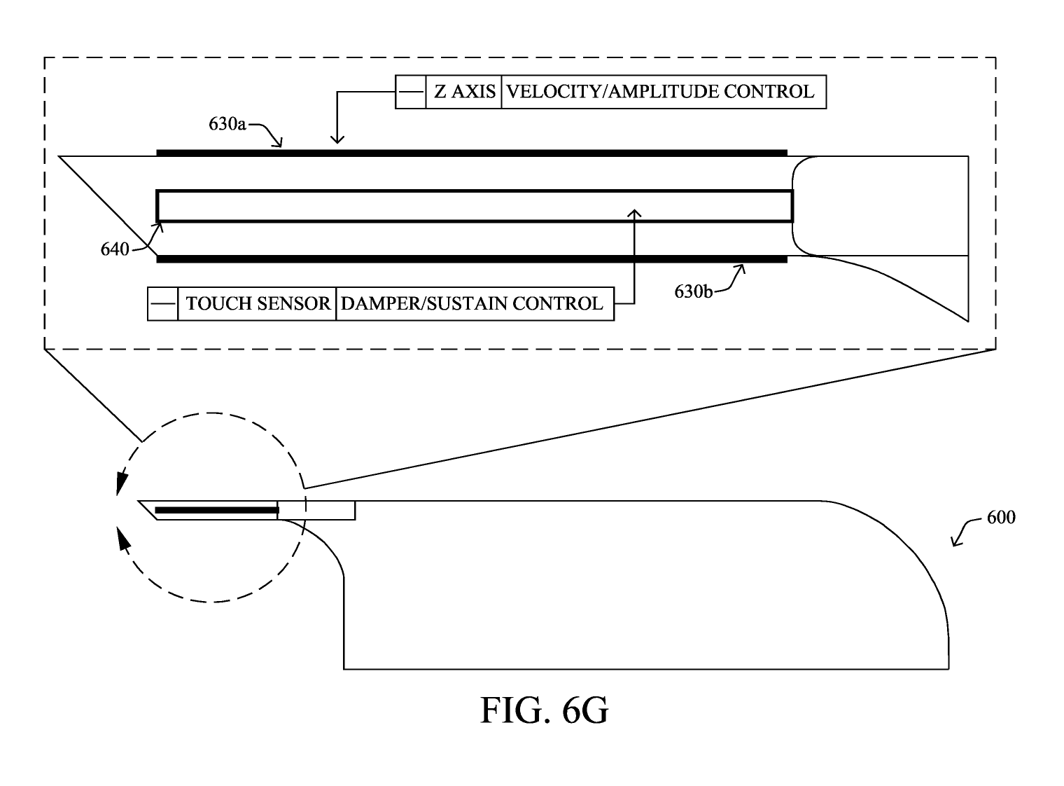

Various overall configurations may be created for the EMI described herein, such as a portable version, a desktop version, a tablet version, a complete/embedded version, and so on. For instance, FIGS. 6A-6G illustrate an example of a particular implementation of the EMI 600 herein, where a thin portable body 610 contains the sensors designed to be played while strapped over the shoulder (similar to guitar or keytar). For instance, a pitch selection component 620 and articulators 630 (e.g., 630a and 630b for dual-sided opposing articulators), as well as an illustrative damper 640 (e.g., for envelope sustain override), may be placed in playable locations on the EMI as shown (e.g., a body portion for the pitch selection component 620 and a neck portion for the articulation sensors 630, as shown). Alternatively, the pitch sensor and articulation sensor may be switched, such that a different hand is used to control pitch and articulation than the arrangement as shown. (That is, though one particular embodiment is shown, the techniques herein are not limited to right-handed or left-handed use of either the pitch selection component 620 or the articulator(s) 630.)

According to the example embodiment EMI 600 in FIGS. 6A-6G, any type of pitch control device 620 may be used, such as a keyboard or a touch screen (e.g., displaying a keyboard), as noted above. As such, while selecting the pitch with one hand (e.g., a single note, a chord, etc.), the articulation control as described herein may then be controlled by the user's other hand through use of the articulator(s) 630 (and optionally damper 640) as detailed above (e.g., pressing, tapping, strumming, sliding, squeezing, and so on). Notably, as shown in FIG. 6F, the X axis may specifically control timbre, though other controls are possible, as described herein.

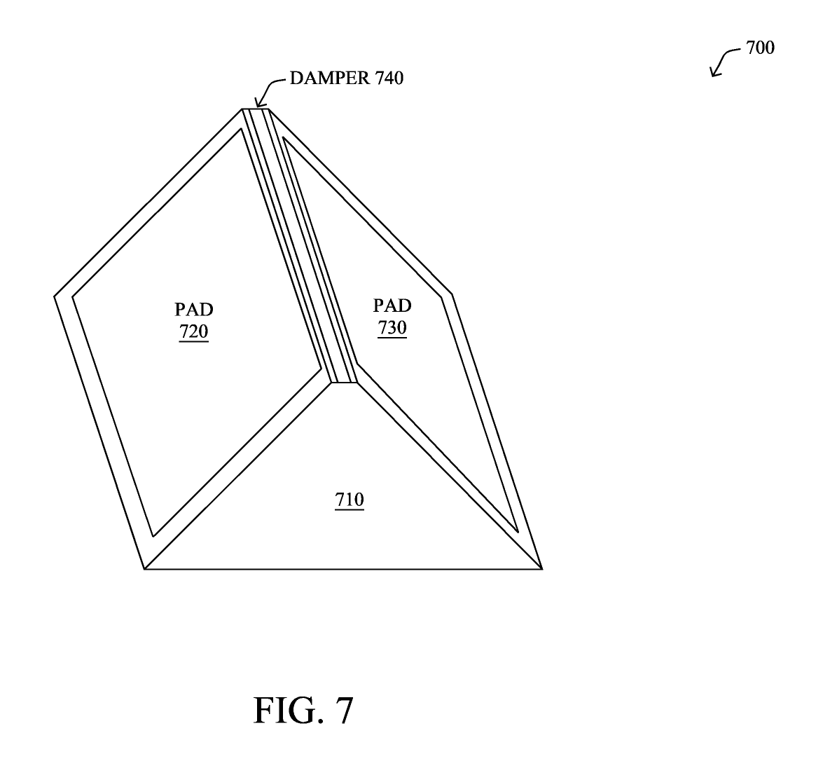

In still another embodiment, a table-top version of the articulation sensors may be designed, such as the example three-sided device 700 as shown in FIG. 7. For instance, device 700 may be used directly with a laptop, tablet, or other pitch control via a software connection, accordingly, e.g., as a peripheral device. To achieve dual-sided action, a is block 710 of any suitable shape (e.g., triangular) may support two opposing pads/sensors 720/730, and optionally a damper 740, as mentioned above (where, notably, the final surface is in supportive contact with a horizontal surface, such as a table, instrument, etc.). As noted above, the two XYZ sensors may be (though need not be) identical in size and shape, and mirror axis movements such that natural movements from both sides intuitively result in the same expressions. That is, in one embodiment as an alternative to synchronized articulation pads, as mentioned above, each pad may offer individual input and control, for more advanced control and instrument play.

In fact, according to one or more embodiments herein, a peripheral control device may also be configured for any EMI, comprising at least one touch-sensitive control sensor (by which notes are modified and/or triggered) that senses one or more of a velocity, pressure, movement, and location of a user's contact, as described above. That is, a peripheral device is generally defined as any auxiliary device that connects to and works with the EMI in some way. For instance, the peripheral control device may interface with the EMI, or with the EMI controller software (e.g., MAINSTAGE). As described below, the design facilitates a portable, ergonomic, and intuitive way to express music via standard digital protocols (e.g., MIDI) through a peripheral physical interface that encourages fluid, non-static, personally distinguishable musical expression.

For instance, according to one or more embodiments herein, an XYZ Pad Expression Controller (e.g., an “expression sensor”) as mentioned above may respond simultaneously to three dimensions of touch (e.g., XY-axis location and Z-axis pressure) that may be rendered to MIDI. There are a wide number of potential musical uses, as described above, such as X for timbre, Y for envelope, and Z for velocity. As an alternative example for a peripheral device (or any device), the following actions may be configured:
X axis⇒Pitchbend−Natural pitch (no bend), which can be fixed at a left/right center line, or else based on wherever a user first touches the pad (no need to find the center). Right touch or movement can thus bend the note(s) sharp, while left touch or movement bends flat.
Y axis⇒Modulation control (e.g., Up/Down movement for more/less is effect).
Z axis⇒Channel Aftertouch (increased pressure on the pad increases effect).

Other configurations may be made, such as using different quadrants of the device for different controls, or else defining regions where different controls do or do not function (e.g., for the Y axis, having only the upper ⅔rds of the device being used for modulation, while the lower 3rd is used for pitchbend with no modulation). The configuration can be changed with standard MIDI program change messages. Illustratively, changes will persist after reboot, though default configurations may also be used.

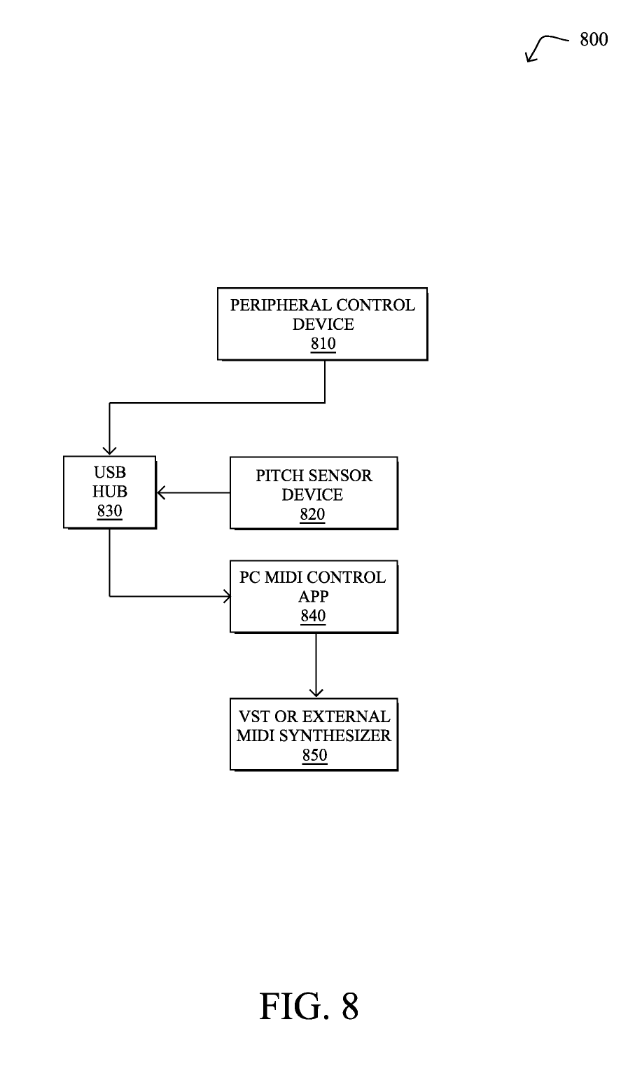

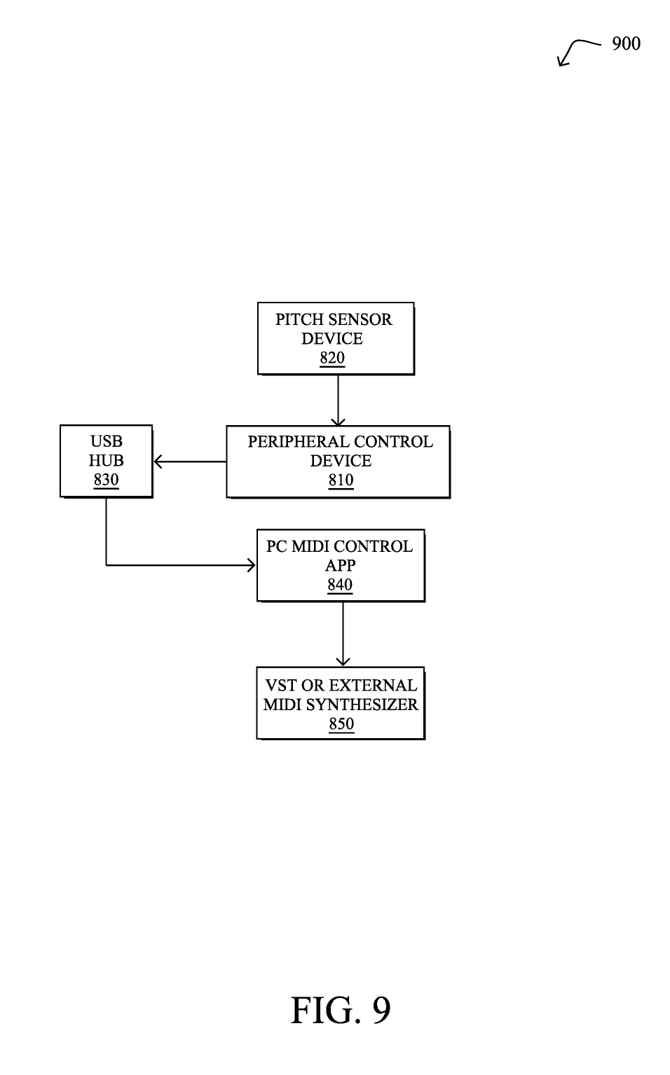

The form factor of the peripheral control device may be any suitable design (shape and/or size), such as the table-top design 700 above, or else any other design (e.g., flat surfaces, add-ons, etc.), some of which being described below. Also, the communication configuration for a peripheral control device may either be “parallel” or “serial”. For example, FIG. 8 illustrates an example block diagram 800 of an illustrative EMI configuration 800 in a parallel configuration (similar to FIG. 3 above), where a peripheral control device/sensor 810 is connected to a USB hub 830, as well as the pitch sensor device 840 (e.g., a keyboard controller). The USB hub may then connect the signal to the MIDI control application 850 and corresponding synthesizer 860. Notably, any number of peripheral control devices 800 may be attached to the system (e.g., different “play” locations on the EMI) in parallel in this manner. Note that other connectivity configurations may be made, such as connecting the peripheral control device directly to the control app, rather than through the USB hub as shown (or also wirelessly connected, such as through BLUETOOTH, Wi-Fi, etc.). Alternatively, as io shown in the configuration 900 of FIG. 9, the peripheral control device may be placed in-line (serially) along the MIDI/USB connection between the pitch sensor device (EMI) and the USB hub (or directly to the control app). Also, while an EMI may generally consist of a physical instrument, software-based instruments may also be configured to utilize the techniques herein though a periphery control device (e.g., plugged into a is laptop).

As mentioned, various configuration control for the functionality of the peripheral control device may be based on manufacturer-configured (static) configurations, or else may be controlled by the user through a control app interpretation of the input signals, or else on the device itself, such as via wireless or wired connection to a computer (e.g., phone, tablet, laptop, etc.).

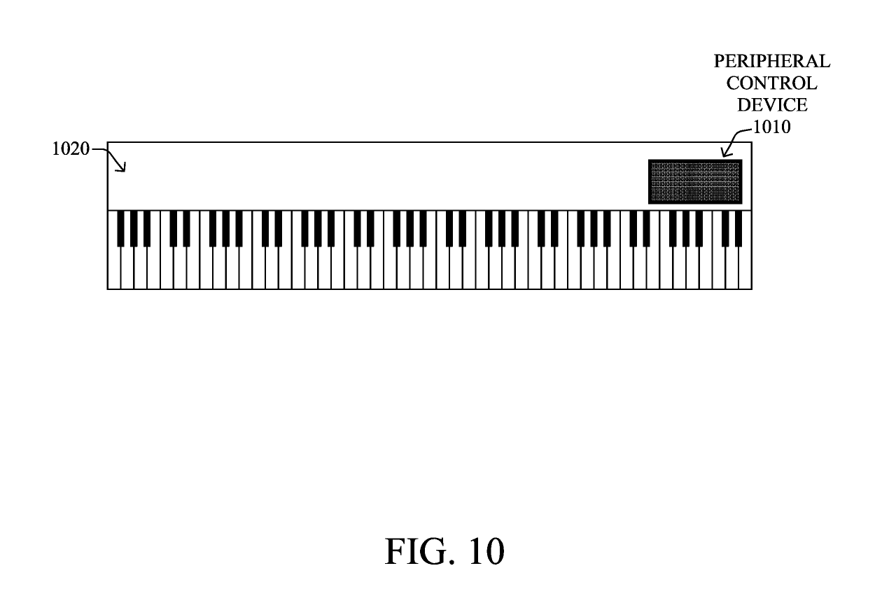

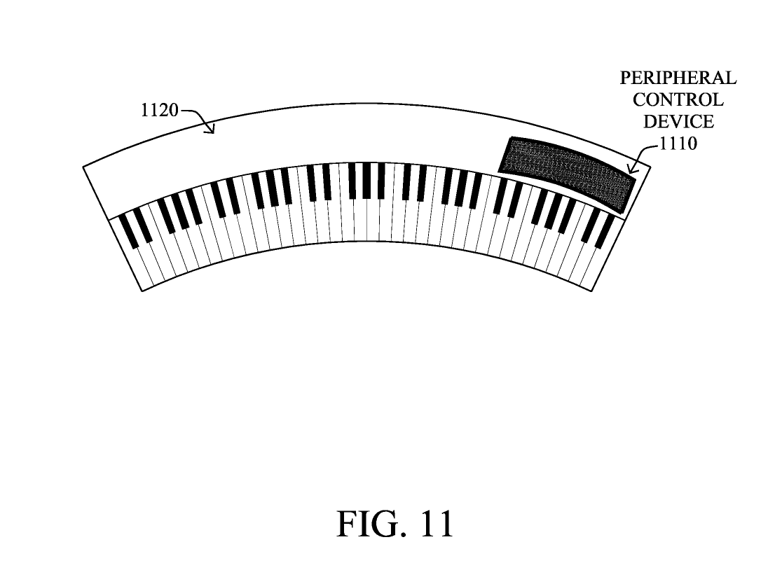

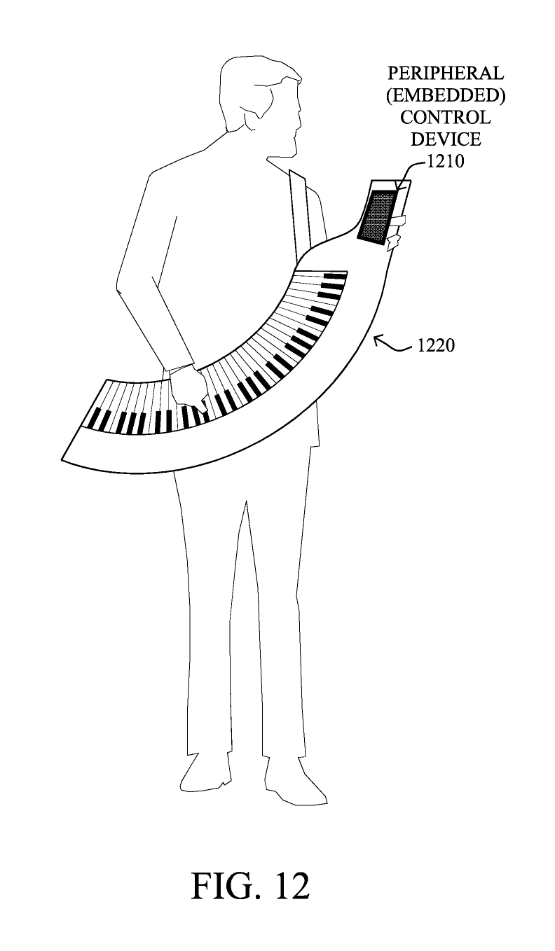

FIGS. 10-12 illustrate further example embodiments and configurations (placements) of peripheral control devices. For instance, FIG. 10 illustrates an example of a rectangular device 1010 placed on a rectangular keyboard 1020, and FIG. 11 illustrates an example of a curved device 1110 placed on a curved keyboard 1120. FIG. 12 illustrates another example configuration of a peripheral control device 1210 being attached to the “neck” of a keytar controller 1220. Still other arrangements and configurations may be made, such as being attached to both sides of a keytar controller (thus creating an instrument similar to that shown in FIGS. 6A-6G above), and those shown herein are merely examples for discussion and illustration of the embodiments and aspects described herein. For example, other features, such as indicator lights, ports (e.g., USB, MIDI), and so on may be located on the device. Note that the size and shape of the peripheral control device can be configured for any suitable design, such as rectangular, square, rounded, circular, curved, triangular, etc., and the views shown herein are not meant to be limiting to the scope of the present disclosure. That is, functionally similar shapes or configurations (e.g., size considerations, shape considerations, and so on), including whether the peripheral device is multi-faceted or single-faceted, lying flat or supported in an inclined/upright manner, etc., may be adapted without parting from the spirit of the embodiments shown herein.

The techniques described herein, therefore, provide generally for an electronic io musical instrument with separated pitch and articulation controls. Advantageously, the embodiments herein solve several problems faced by existing electronic musical instruments. In particular, by separating pitch from percussion/articulation, the embodiments herein provide greater detail for expression of each note, improved rhythmic feel, natural pitch movement, and more precise velocity control. In addition, is the specific embodiments shown and described above provide for comfortable and intuitive ergonomics of sensors, particularly the two-sided articulation XYZ sensors, in a manner that illustratively provides many (e.g., seven) parameters of control, which are conventionally only available through sliders and knobs on a production board (where even a production board doesn't allow for simultaneous control of the parameters).

Specifically, the articulator described above provides an intuitive way to modify timbre, envelope, and sustain in real-time, and there is no need for extra hands to manipulate cumbersome pedals or sliders. Also, while playing a touchscreen instrument, the articulator provides a way to add velocity (volume/force) control. For keyboardists, the EMI techniques herein provides polyphonic legato, seamless slides between notes/chords, and easy re-triggering of single notes/chords in a percussion style in a way never before available. For guitarists, the EMI techniques herein provide a low-latency MIDI, multiple notes “per-string”, and pitch-bending between strings. Even further, for microtonalists, the techniques herein can provide a matrix interface or any alternative scale. Still further, the EMI herein can provide a way for beginners to play chords easily.

Furthermore, the techniques described herein may also provide generally for a peripheral control device for electronic musical instruments. In particular, by adding a control device to a legacy EMI, or else to an EMI with limited capability, the embodiments herein can still provide greater detail for expression of each note for any EMI.

Note also that pitch selection may be capable of seamless detection of pitch in between notes, i.e., independent note pitch-bend (e.g., multidimensional polyphonic expression, “MPE”). The techniques herein, therefore, also solve the issue of pitch-bend not being per note via the MIDI specification, whether directly incorporating MPE io capability or else by being compatible with MPE-processing software.

Note that the embodiments above also provide the benefit, in certain configurations, of being a self-contained virtual studio technology (VST) device, where there is no need to connect the device to a phone, tablet, or PC, simply allowing the device to be plugged directly into an amp or PA system.

Those skilled in the art will appreciated that although certain embodiments, form factors, aspects, and use-cases, and particularly their associated advantages, have been described above, it should be noted that the opportunity for other arrangements may be contemplated according to the details described above that may provide additional advantages than those mentioned herein.

Illustratively, the certain techniques described herein may be performed by hardware, software, and/or firmware, such as in accordance with the various processes of user devices, computers, personal computing devices (e.g., smartphones, tablets, laptops, etc.), online servers, and so on, which may contain computer executable instructions executed by processors to perform functions relating to the techniques described herein. That is, various systems and computer architectures may be configured to implement the techniques herein, such as various specifically-configured electronics, embedded electronics, various existing devices with certain programs, applications (apps), various combinations there-between, and so on.

For example, various computer networks (e.g., local area networks, wide area networks, the Internet, etc.) may interconnect devices through a series of communication links, such as through personal computers, routers, switches, servers, and the like. The communication links interconnecting the various devices may be wired or wireless links. Those skilled in the art will understand that any number and arrangement of nodes, devices, links, etc. may be used in a computer network, and any connections and/or networks shown or described herein are merely for example.

Illustratively, the computing devices herein (e.g., the EMI, the peripheral control device, or any device configured to operate in conjunction with the EMI or peripheral io control device) may be configured in any suitable manner. For example, the device may have one or more processors and a memory, as well as one or more interface(s), e.g., ports or links (such as USB ports, MIDI ports, etc.). The memory comprises a plurality of storage locations that are addressable by the processor(s) for storing software programs and data structures associated with the embodiments described herein. The processor(s) is may comprise necessary elements or logic adapted to execute software programs (e.g., apps) and manipulate data structure associated with the techniques herein (e.g., sounds, images, input/output controls, etc.). An operating system may be used, though in certain simplified embodiments, a conventional sensor-based configuration may be used (e.g., MIDI controllers with appropriate sensor input functionality).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes may have been shown separately, or on specific devices, those skilled in the art will appreciate that processes may be routines or modules within other processes, and that various processes may comprise functionality split amongst a plurality of different devices (e.g., controller/synthesizer relationships).

In addition, it is expressly contemplated that certain components and/or elements of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards, optical data storage devices, and other types of internal or external memory mediums. The computer readable recording medium can also be distributed in network coupled computer systems so that the computer readable media is stored and executed in a distributed fashion.

While there have been shown and described illustrative embodiments that provide for an electronic musical instrument with separate pitch and articulation control, or also a peripheral control device for an electronic musical instrument, it is to be understood that various other adaptations and modifications may be made within the spirit and scope of the embodiments herein, with the attainment of some or all of their advantages. For instance, though much of the example above illustrates certain configurations and styles (e.g., “look and feel”), other arrangements or configurations may be made, and the techniques herein are not limited to merely those illustrated in the figures. That is, it should be understood that aspects of the figures depicted herein, such as the depicted functionality, design, orientation, terminology, and the like, are for demonstration purposes only. Thus, the figures merely provide an illustration or the disclosed embodiments and do not limit the present disclosure to the aspects depicted therein. Also, while certain protocols are shown and described, such as MIDI, the embodiments herein may be used with other suitable protocols, as may be appreciated by those skilled in the art.

Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
receiving, by an electronic musical instrument, a pitch selection signal from a pitch selection sensor;
determining, by the electronic musical instrument, a pitch selection based on the pitch selection signal;
receiving, by the electronic musical instrument, an articulation trigger signal from an articulation sensor;
determining, by the electronic musical instrument, an articulation action based on the articulation trigger signal;
combining, by the electronic musical instrument, the pitch selection and the articulation action into musical instructions; and
sending, from the electronic musical instrument, the musical instructions to a sound generator to cause the sound generator to generate musical sounds according to the musical instructions.

2. The method as in claim 1, wherein the pitch selection comprises one or more of notes and bends.

3. The method as in claim 1, wherein the articulation action comprises one or more of velocity and spatial movement corresponding to one or more musical effects.

4. The method as in claim 1, wherein the sound generator is one of either a virtual studio technology (VST) system or an external synthesizer.

5. The method as in claim 1, further comprising:
combining the pitch selection and the articulation action into the musical instructions and sending the musical instructions to the sound generator in response to the articulation action being activated when the pitch selection signal is received.

6. The method as in claim 1, further comprising:
in response to the articulation action not being activated when the pitch selection signal is received, storing the pitch selection until the articulation action.

7. The method as in claim 6, wherein storing comprises storing a note-on pitch selection, the method further comprising:
deleting the stored note-on pitch selection in response to a corresponding note-off pitch selection.

8. The method as in claim 1, wherein the articulation sensor is a multi-faceted articulation sensor with a plurality of articulation sensors.

9. An electronic musical system, comprising:
a multi-faceted articulation sensing device having a first articulation sensor and a second articulation sensor, each configured to collect articulation trigger signals and to transmit the articulation trigger signals; and
a pitch selection sensor configured to collect pitch selection signals and to transmit the pitch selection signals;
wherein the transmitted articulation trigger signals and pitch selection signals cause musical control circuitry to determine articulation actions and pitch selections based on the articulation trigger signals and pitch selection signals, respectively, and to combine the articulation actions and pitch selections into musical instructions for a sound generator to generate musical sounds according to the musical instructions.

10. The electronic musical system as in claim 9, wherein the musical control circuity is integrated with the multi-faceted articulation sensing device and pitch selection sensor.

11. The electronic musical system as in claim 9, wherein the musical control circuity is separate from the multi-faceted articulation sensing device and pitch selection sensor.

12. The electronic musical system as in claim 9, wherein the pitch selection sensor comprises a graphical display of an instrument.

13. The electronic musical system as in claim 12, wherein the instrument comprises piano keys.

14. The electronic musical system as in claim 9, wherein the first articulation sensor and second articulation sensor comprise XY control, wherein an X control direction corresponds to a first musical effect, and wherein a Y control direction corresponds to a second musical effect.

15. The electronic musical system as in claim 14, wherein the first articulation sensor and second articulation sensor further comprise Z control, wherein a Z control direction corresponds to a third musical effect.

16. The electronic musical system as in claim 14, wherein musical effects are selected from a group consisting of: activation; velocity; harmonic content; and envelope.

17. The electronic musical system as in claim 9, wherein the multi-faceted articulation sensing device comprises a third sensor for controls selected from a group consisting of: mute; sustain; damper; and control program change.

18. The electronic musical system as in claim 9, wherein the multi-faceted articulation sensing device is separate from the pitch selection sensor and is configured for supportive contact with a horizontal surface.

19. The electronic musical system as in claim 9, wherein the pitch selection comprises one or more of notes and bends, and wherein the articulation action comprises one or more of velocity and spatial movement corresponding to one or more musical effects.

20. The electronic musical system as in claim 9, further comprising:
a body portion on which the pitch selection sensor is located; and
a neck portion on which the multi-faceted articulation sensing device is located.
